(19) United States
(12) Patent Application Publication
(10) Pub. No.: US 2007/0076132 A1
(43) Pub. Date: Apr. 5, 2007

(54) [SIGNAL ADJUSTER]

(75) Inventor: Chang-Pin Wang, TAIPEI (TW)

Correspondence Address: SURE-FIRE ELECTRICAL CORPORATION, 2F-4, NO. 148, SEC. 4, CHUNG HSIAD E. ROAD, TAIPEI, TW

(73) Assignee: SURE-FIRE ELECTRICAL CORPORATION, Hsinchuang City (TW)

(21) Appl. No.: 11/163,092

(22) Filed: Oct. 5, 2005

(51) Int. Cl. H04N 3/14

(52) U.S. Cl. 348/790

(57) ABSTRACT

A signal adjuster is disclosed to include a first connector connected to a signal source through a high-frequency signal cable, a second connector connected to a video output device, a buffer connected between the first connector and the second connector, an adjustable equalizer connected between the buffer and the second connector for adjusting signal strength of a high frequency signal from the signal source, an amplifier for amplifying the enhanced high frequency signal from the adjustable equalizer, and a driver for driving the second connector to output the amplified high frequency signal from the amplifier to the video output device.

### BACKGROUND OF THE INVENTION

1. Field of the Invention

The present invention relates to signal adjuster and more particularly, to a signal adjuster for connection between a signal source and a video output device through a high-frequency signal cable to enhance the strength of the high frequency signal from the signal source and to amplify the enhanced high frequency signal for output to the video output device.

2. Description of the Related Art

In recent years, there is a great change in audio and video application industry. In consequence, a variety of audio and video devices have been developed and intensively used in our daily life. These audio and video devices including CD/VCD/DVD players, high resolution digital TVs, video phones and videoconference systems commonly use a digitalized technology to process audio signal in video signal. Following different application requirements, related protocols have been well defined. For example, DVI (Digital Video Interface) is a connection standard for connection between a display card system and a display device, for particularly, a digital display device. A DVI display card system comprises a transmitter and a receiver. The transmitter can be built in the display card system. DVI is established subject to TMDS (Transition Minimized Differential Signaling) protocol, i.e., PanelLink technology that supports VGA to QXGA (2048˜1600) resolution, has the pulse speed of 25˜165 MHz. The bandwidth can reach 1.65 Gbps during transmission under one single channel link, or over 2 Gbps during transmission under two channel links. TMDS allows transmission of analog signal, therefore it is connectable to a conventional CRT monitor.

Early analog TVs adopt analog signal only. Analog signal uses a low frequency as the transmission interface. Low frequency allows transmission of only one signal at a time. The picture quality of an analog TV is less clear. In recent years, digital TVs have been intensively used to substitute for conventional analog TVs. A digital TV accepts transmission of multiple image signals at a time. For transmission of a big amount of video data, a digital TV uses a high frequency interface for signal transmission. This high frequency interface is used an application of HDMI (High Definition Multimedia Interface) cable that provides an uncompressed digital link between consumer electronics equipment such as DVD players, set-top boxes and audio/video monitors such as plasma display screens for HDTV's. HDMI supports standard, enhanced, or high-definition video, plus multi-channel digital audio on a signal cable. It transmits all ATSC HDTV standards and supports 8-channel digital audio, with bandwidth to spare to accommodate future enhancements and requirements.

However, when multiple users share one single high-frequency signal cable through a router and there is a long distance between transmitter side and receiver side, the signal will be attenuated following the increasing of the distance between the transmitter side and the receiver side, and the images will be interfered with noises. Due to this drawback, a high-frequency interface may be not usable in certain fields. Further, in order to eliminate noises during transmission of a signal to a digital TV through the cable, a signal adjuster may be attached to the transmitter side or the receiver side to enhance the signal.

Although many new video signal transmission interface means have been continuously developing, there is still a limitation to the effective transmission distance. The use of a conventional signal adjuster in a high-frequency signal cable still cannot allow a great extension of the length of the high-frequency signal cable.

### SUMMARY OF THE INVENTION

The present invention has been accomplished under the circumstances in view. It is the main object of the present invention to provide a signal adjuster which enhances the high frequency signal received from a signal source through a high-frequency signal cable and amplifies the enhanced high frequency signal for output to a video output device so that the length of the high-frequency signal cable connected between the signal source and the video output device can be greatly extended. To achieve this and other objects of the present invention, the signal adjuster comprises a first connector connected to a signal source through a high-frequency signal cable for receiving a high frequency signal from the signal source, a second connector connected between the first connector and a video output device for output of the high frequency signal to the video output device, a buffer connected between the first connector and the second connector for storing the high frequency signal temporarily, a driver connected between the buffer and the second connector for driving the second connector to output the high frequency signal from the buffer to said video output device, an adjustable equalizer and an amplifier connected in series between the buffer and the driver for adjusting the strength of the high frequency signal received from the first connector through the buffer and amplifying the enhanced high frequency signal for output to the video output device through the driver and the second connector.

### BRIEF DESCRIPTION OF THE DRAWINGS

FIG. 1 is an elevational view of a signal adjuster according to the present invention.

FIG. 2 is a system block diagram of the present invention.

FIG. 3 is an applied view of the present invention.

### DETAILED DESCRIPTION OF THE PREFERRED EMBODIMENT

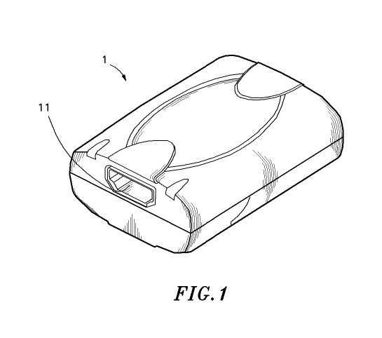

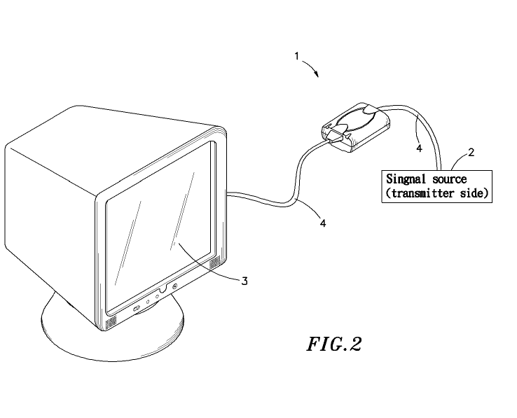

Referring to FIGS. 1 and 2, a signal adjuster is shown comprising a first connector 11, a buffer 12, an adjustable equalizer 13, am amplifier 14, a driver 15, and a second connector 16. These component parts 11˜16 are housed in an electrically insulative housing 1.

The first connector 11 is adapted to receive signal from a signal source (the transmitter side) 2.

The buffer 12 is electrically connected to an output end of the first connector 11, and adapted for temporarily storing high frequency signal received from the first connector 11.

The adjustable equalizer 13 is electrically connected to an output end of the buffer 12, and adapted to adjust the strength of high frequency signal received from the buffer 12.

The amplifier 14 according to this embodiment is an operation amplifier electrically connected to an output end of the adjustable equalizer 13, and adapted to amplify high frequency signal received from the adjustable equalizer 13.

The driver 15 is electrically connected to an output end of the amplifier 14 and adapted to receive high frequency signal from the amplifier 14, having a power indicator light 151 and a connection indicator light 152 connected thereof.

The second connector 16 is electrically connected to the driver 15 and adapted to receive high frequency signal from the driver 15 and to output received high frequency signal to a video output device 3. The video output device 3 can be a LCD TV or computer monitor.

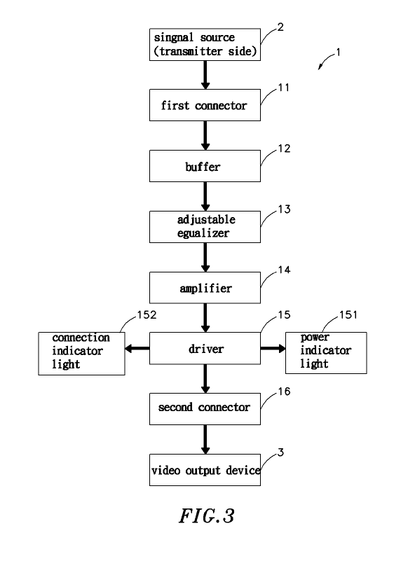

Referring to FIG. 3 and FIG. 2 again, when switched on power supply, the power indicator light 151 is turned on to provide electric current to the signal adjuster. When the connection indicator light 152 is turned on at this time, it means the signal source 2 and the video output device 3 has been properly connected to the signal adjuster through the high-frequency signal cables 4. When the signal source 2 outputs a high frequency signal to the first connector 11, the first connector 11 transmits the high frequency signal to the buffer 12 and then to the adjustable equalizer 13, which processes the high frequency signal through a wave enhancing and filtering process and then sends the processed high frequency signal to the amplifier 14 for amplification. The amplifier 14 sends the amplified high frequency signal to the driver 15, which drives the second connector 16 to transmit the amplified high frequency signal to the video output device 3 for output. Further, the adjustable equalizer 13 of the signal adjuster is adjustable subject to the length of the high-frequency signal cable 4 between the signal source 2 and the video output device 3. Therefore, the use of the signal adjuster allows extension of the length of the high-frequency signal cable 4.

As indicated above, the invention provides a signal adjuster installed in the high-frequency signal cable between a signal source and a video output device to enhance the strength of the high frequency signal outputted from the signal source and to amplify the enhanced high frequency signal, enabling the high frequency signal to be well received by the video output device for output. Further, the signal strength of the signal adjuster is adjustable subject to the length of the high-frequency signal cable so that the video output device can receive the high frequency signal from the signal source at a far place through the high-frequency signal cable.

Although a particular embodiment of the invention has been described in detail for purposes of illustration, various modifications and enhancements may be made without departing from the spirit and scope of the invention.

What is claimed is:

1. A signal adjuster comprising a first connector connected to a signal source through a high-frequency signal cable for receiving a high frequency signal from said signal source, a second connector connected between said first connector and a video output device for output of said high frequency signal to said video output device, a buffer connected between said first connector and said second connector for storing said high frequency signal temporarily, and a driver connected between said buffer and said second connector for driving said second connector to output said high frequency signal from said buffer to said video output device, wherein the signal adjuster further comprises an adjustable equalizer and an amplifier connected in series between said buffer and said driver for adjusting the strength of said high frequency signal received from said first connector through said buffer and amplifying the enhanced high frequency signal for output to said video output device through said driver and said second connector.

2. The signal adjuster as claimed in claim 1, wherein said video output device is a LCD TV.

3. The signal adjuster as claimed in claim 1, wherein said video output device is a computer monitor.

4. The signal adjuster as claimed in claim 1, wherein said amplifier is an operation amplifier.

5. The signal adjuster as claimed in claim 1, wherein said driver has a power indicator light and a connection indicator light electrically connected thereto for indication of power supply status and electric connection status between said signal source and said video output device.
